(19) United States
(12) Patent Application Publication
(10) Pub. No.: US 2022/0168816 A1
(43) Pub. Date: Jun. 2, 2022

(54) METHOD AND APPARATUS FOR THE ADDITIVE MANUFACTURE OF PRODUCTS FROM METAL ALLOYS

(71) Applicant: ThixoAM GmbH, Berlin (DE)

(72) Inventor: Lars Herhold, Berlin (DE)

(21) Appl. No.: 17/437,462

(22) PCT Filed: Mar. 17, 2020
(86) PCT No.: PCT/DE2020/000067

§ 371 Date: Sep. 9, 2021

(30) Foreign Application Priority Data
Mar. 22, 2019 (DE) 10 2019 002 203.3

(51) Int. Cl. B22F 12/53; H05B 6/10; H05B 6/36; H05B 3/42; B33Y 10/00; B33Y 30/00; B22F 10/22

(52) U.S. Cl. CPC B22F 12/53; H05B 6/101; H05B 6/365; H05B 3/42; B22F 10/85; B33Y 30/00; B22F 10/22; H05B 2203/002; B33Y 10/00

(57) ABSTRACT

An apparatus and a method for an extrusion-based additive manufacture of products from thixotropic metal alloys, with a feeder (2) for the starting material, wherein the starting material is in bar form (3), with a preheating device in the form of an induction coil (8) including a cap for field concentration (7), which encloses the channel (6), with a heater (10) for producing a semi-solid processing state of the preheated starting material, which likewise encloses the channel (6), with an afterheater (13) in the region of the die (11) and with an adjustable workpiece table (15) for the product to be built up layer by layer.

The invention relates to the extrusion-based additive manufacture of products and semi-finished products from metal alloys, e.g., from thixotropic aluminum alloys and, in particular, from the alloys A-356/EN AC-42100/EN 1706 (AlSi7Mg0.3 as well as THIXALLOY 540 (AlMg5Si2Mn).

Additive manufacture is a method in which a component part is built up layer by layer on the basis of 3D data. Whereas, in the past, powder bed fusion methods were mainly used, extrusion-based manufacturing methods are increasingly being utilized in order to generate workpieces from metal.

Thus, US 2018/0345573 A1 describes an extrusion-based manufacturing method, on the basis of 3D printing, in which a metal wire (filament) is utilized, in which said metal wire is supplied to a liquefier which produces a melt in a chamber, which melt is applied via an extrusion tube layer by layer to a surface of a workpiece table. An inert gas pressure is utilized in order to press the melt out of the extrusion tube. A relative movement between the liquefier and the workpiece table is provided for the application. In addition, it should be possible to heat the workpiece table in order to influence the metal solidification and the crystal structure. The use of bismuth, of bismuth telluride components as well as aluminum, aluminum components and/or aluminum alloys is highlighted.

DE 10 2014 018 081 A1 provides an additive manufacture by means of extrusion of metal composites in a 3-stage method, namely the manufacture of a green part, the discharging of the green part and the sintering of the green part. During the pressing process, only the composite proportion is plasticized, which is effected at a low temperature level.

Amorphous metals are processed in US 2018/0 318 933 A1. Ultrasonic transmitters are deployed in order to prevent retention on the walls of the die.

The object of the invention is to illustrate and to optimize the conditions for an extrusion-based additive manufacture of workpieces from thixotropic (partially liquid processing) metal alloys, e.g., aluminum alloys.

This object is achieved with Claims 1, 13 and 17. Advantageous configurations are the subject-matter of the subclaims.

The apparatus according to the invention for an extrusion-based additive manufacture of products from a thixotropic metal alloy, comprising a feeder for the starting material, wherein the starting material is in bar form and has a globulitic structure ready for processing, comprising a male and a female end so that the bars can be joined one after the other to form a rod by the male end engaging in the female end and the joined bars being displaceably arranged through a channel to a heatable die channel of a die, in which the joined bars are pressed by a propulsion-producing device, which engages in corresponding recesses of the joined bars, into the channel so that they simultaneously serve as pistons for the extrusion of the produced semi-solid material, comprising a preheating device in the form of an induction coil including a cap for field concentration, which encloses the channel, comprising a heater in the form of resistance heating for producing the semi-solid processing state of the preheated starting material, which likewise encloses the channel, and the heating surface of which is kept small in order to minimize starting material agings in the form of the enlargement of the globulites in the metal structure, comprising an afterheater in the region of the die and comprising an adjustable workpiece table for the product to be built up layer by layer.

The necessary ratio of liquid and solid material for the extrusion-based additive manufacture can be optimally set with this arrangement and kept up to the layer-by-layer application.

The propulsion-producing device in the form of a gear conveyor or a worm conveyor engages in corresponding recesses of the joined bars, wherein the recesses are advantageously those of a toothed rod or a threaded rod. The required pressing forces of approximately 200 N/cm² can only be achieved for A356/AlSi₇Mg thanks to such conveyors. The starting forces must be particularly high.

In the case of a feed with a worm conveyor, it is advantageous if the joined bars contain a guide groove and the channel has a guide interacting with the guide groove, which guide prevents the bars from turning away during propulsion as pistons.

In the case of a preferred embodiment of the apparatus, the preheating device, the heater, the die comprising the die channel and the workpiece table are arranged in a housing which can be filled with inert gas.

This ensures that a partial melt can take place without the risk of contamination by reactive gases occurring in the air such as, e.g., oxygen and carbon dioxide.

A multi-circuit resistance heater is deployed as a heater, in the case of a proven embodiment, in order to bring the metal alloy into a precise partially liquid state, and to keep it there. The working temperature is approximately 600° C.

The heating surface is deliberately kept small in order to minimize agings of the starting material in the form of the enlargement of the globulites in the metal structure.

A further development additionally provides that an ultrasonic generator for maintaining the uniform distribution of the solid (globulites) and liquid material constituents and/or for cleaning purposes is arranged in the region of the die.

A demixing between the solid and liquid proportions is thus counteracted. This is particularly necessary in the start/stop phase or in the event of changes in extrusion speeds.

Likewise, an induction coil or a laser is deployed in order to subsequently heat the extrusion material and/or in order to preheat the already deposited material layers.

The channel in the region of the induction coil for preheating is formed by a sleeve made of glass or ceramic. The advantage of this is that the electromagnetic field can heat the bars in a virtually unhindered manner.

A further advantageous configuration provides that the die channel has a ceramic nonstick coating, e.g., a boron nitride coating, in order to prevent bonding or to keep the necessary feed force slightly lower.

A further configuration of the apparatus according to the invention provides for a time control which can be set such that, in the event of globulites which are becoming larger in size emerging, which can lead to clogging of the die, extrusion takes place in the waste. Therefore, a waste collector is arranged on the workpiece table.

The method according to the invention for an extrusion-based additive manufacture of products from a thixotropic metal alloy, in which a fed starting material is brought into a semi-solid processing state by heating, extruded through a die and is applied layer by layer to a product to be built up, takes up the idea of using the starting material as an extrusion piston, in which the not yet liquefied starting material has a structure ready for processing comprising a globulitic structure, is in bar form, comprising a male and a female end so that the bars can be joined one after the other to form a rod by the male end engaging in the female end and the rod being utilized as a piston for the extruding by introducing a feed force into said starting material, wherein a preheating device and a heater in the form of resistance heating are deployed for heating, wherein the heating surface of the resistance heating is kept so small that starting material agings in the form of the enlargement of the globulites are minimized.

To ensure that the structure which is capable of processing is preserved, provision is made for the feeder for the starting material in an apparatus for the extrusion-based manufacture of products from a thixotropic metal alloy, comprising a storage container for exchangeable bar-shaped starting material and comprising a guide channel for the bar-shaped starting material to a channel, in which the starting material is prepared for the extrusion, wherein the bar-shaped starting material can be connected on the inlet side into the channel to form a rod by a male end of a bar engaging in each case into a female end of the preceding bar, the storage container and the guide channel for the starting material from the storage container to the channel for the extrusion are filled with a protective gas.

The invention will be explained with reference to the drawings, wherein:

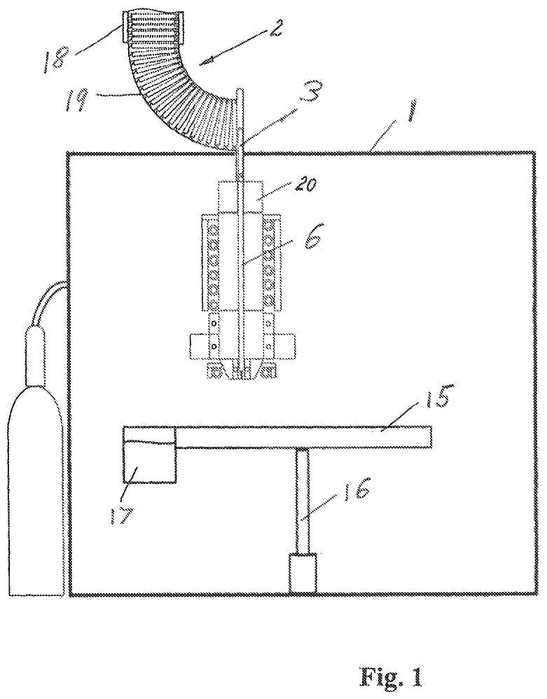

FIG. 1 shows the complete apparatus,

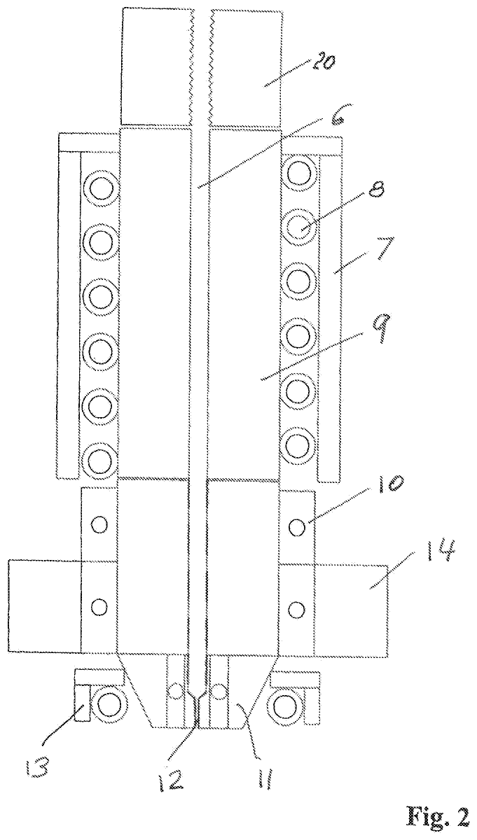

FIG. 2 shows the preparation of the material, and

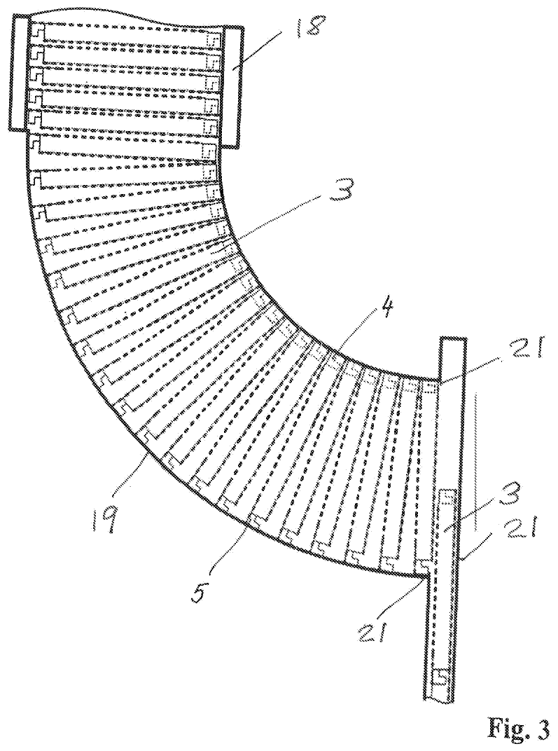

FIG. 3 shows a feeder.

FIG. 1 shows an apparatus according to the invention for an extrusion-based additive manufacture of products from a metal alloy, preferably from thixotropic aluminum alloys and, in particular, from the alloys A-356/EN AC-42100/EN 1706 (A1Si7Mg0.3 as well as THIXALLOY 540 (AlMg5Si2Mn).

The apparatus has a feeder 2 for the starting material, which feeder is arranged outside of the housing 1. The starting material is in bar form 3, comprising a male and a female end 4, 5 so that the bars 3 can be joined one after the other to form a rod. The joined bars 3 are displaced through a channel 6 to a heatable die channel 12 of a die 11 and are utilized here in the partially liquid state on an adjustable workpiece table 15 in order to build up a product layer by layer.

With the transfer of the bars 3 into the channel 6, they are located together with the further equipment in a housed space, the housing 1, which is filled with an inert gas, so that during the partial melt which takes place, the risk of a contamination by reactive gases occurring in air such as, e.g., oxygen and carbon dioxide, is excluded.

The workpiece table 15 which is likewise arranged in the housing 1 can be moved in the coordinates x, y and z by an adjusting device 16. Due to the extensive technical equipment, said workpiece table is more advantageous to move around the channel 6 and the junction with the feeder 2 than said equipment.

It is additionally shown that the workpiece table 15 has a waste collector 17 which receives aged starting material or enlarged starting material (e.g., globulites larger than ⅛ of the die outlet opening).

FIG. 2 shows the equipment for preparing the partial melt up to the output thereof from the die 11. The joined bars 3, which have a globulitic structure ready for processing, preferably comprising an average grain size ≤100 μm, are pressed by a propulsion-producing device 20 into the channel 6 so that they simultaneously serve as pistons for the extrusion of the produced semi-solid material to be output.

Gear conveyors or worm conveyors are deployed as a propulsion-producing device 20, which gear conveyors or worm conveyors engage in corresponding recesses of the joined bars 3, similarly to a toothed rod or a threaded bar.

In the case of a worm conveyor, the joined bars 3 have a guide groove and the channel 6 has a guide interacting with the guide groove so that the bars 3 are held in a position for the joining, and/or a turning away of the bars 3 during propulsion as pistons is prevented.

On the way to the die channel 12, the joined bars 3 pass through processing devices which follow one another:
a preheating device comprising an induction coil 8 and comprising a cap for field concentration 7,
a heater 10 for producing the semi-solid processing state of the preheated starting material, and
an afterheater 13 in the region of the die 11.

The induction coil 8, the cap for field concentration 7 and the heater 10 encase the channel 6 which is formed in the region of the induction coil 8 for preheating by a sleeve 9 made of glass or ceramic.

The heater 10 is preferably a multi-circuit resistance heater in order to bring the metal alloy into a precise partially liquid state and to keep it there. As a result of the fact that the heating surface is kept small, starting material agings in the form of the enlargement of the globulites in the metal structure can be minimized.

A laser or likewise an induction coil is deployed in order to subsequently heat the extrusion material and/or in order to preheat the already deposited material layers.

The formation of large globulites and, associated therewith, the formation of crystalline dendrites results in the material no longer being able to be extruded, as demixing appears, clogging occurs or the viscosity changes considerably.

The indicated two-stage heating counteracts this, as does the ultrasonic generator 14 arranged in the region of the die 11. The latter promotes the maintenance of the uniform distribution of the solid (globulites) and liquid material constituents and/or also assumes cleaning functions. The die channel 12 has a ceramic nonstick coating (e.g., a boron nitride coating).

FIG. 3 shows the feeder 2 for the bar-shaped 3 starting material. The feeder 2 for the starting material comprises the storage container 18 for exchangeable bar-shaped 3 starting material and a guide channel 19 for the bar-shaped 3 starting material to the channel 6, in which the starting material is prepared for the extrusion.

The bar-shaped 3 starting material can be connected on the inlet side into the channel 6 to form a rod, in which a male end 4 of a bar 3 engages in each case in a female end 5 of the preceding bar 3. Actuated release pins 21 ensure that the subsequent rod 3 does not exit from the guide channel until the preceding rod 3 is in the connection position.

The bar-shaped starting material is preferably inserted into the storage container 18 horizontally and is turned about a vertical line to the longitudinal axis of the rod so that the bar-shaped starting material then slides vertically into the channel 6. The advantage of said arrangement with respect to vertical storing is that gravity is used for feeding the bars or the storage containers can be simply replaced during operation.

The storage container 18 and the guide channel 19 are filled with a protective gas, so as not to modify the globulitic microstructure ready for processing of the rods 3.

### LIST OF REFERENCE NUMERALS

1 Housing
2 Feeder
3 Bar-shaped starting material
4 Male end of the bars
5 Female end of the bars
6 Channel
7 Caps for field concentration
8 Induction coil for preheating
9 Sleeve made of glass or ceramic
10 Heater
11 Die
12 Die channel
13 Afterheater
14 Ultrasonic generator
15 Workpiece table
16 Adjusting device for the workpiece table
17 Waste collector
18 Storage container
19 Guide channel
20 Propulsion-producing device
21 Release pins

1. An apparatus for an extrusion-based additive manufacture of products from a thixotropic metal alloy, comprising a feeder (2) for the starting material, wherein the starting material is in bar form (3) and has a globulitic structure ready for processing, comprising a male and a female end (4, 5) so that the bars (3) can be joined one after the other to form a rod by the male end (4) engaging in the female end (5) and the joined bars (3) being displaceably arranged through a channel (6) to a heatable die channel (12) of a die (11), in which the joined bars (3) are pressed by a propulsion-producing device (20), which engages in corresponding recesses of the joined bars (3), into the channel (6), so that they simultaneously serve as pistons for the extrusion of the produced semi-solid material, comprising a preheating device in the form of an induction coil (8) including a cap for field concentration (7), which encloses the channel (6), comprising a heater (10) in the form of resistance heating for producing the semi-solid processing state of the preheated starting material, which likewise encloses the channel (6), and the heating surface of which is kept small in order to minimize starting material agings in the form of the enlargement of the globulites in the metal structure, comprising an afterheater (13) in the region of the die (11) and comprising an adjustable workpiece table (15) for the product to be built up layer by layer.

2. The apparatus according to claim 1, wherein the preheating device (7, 8), the heater (10), the die (11) comprising the die channel (12) and the workpiece table (15) are arranged in a housing (1).

3. The apparatus according to claim 1, wherein the propulsion-producing device (20) is a gear conveyor or a worm conveyor.

4. The apparatus according to claim 3, wherein in the case of a worm conveyor a guide groove/web of the joined bars (3) interacts with a guide web/groove of the channel (6) in order to hold the bars (3) in position for the joining.

5. The apparatus according to claim 1, wherein the heater (10) is a multi-circuit resistance heater in order to bring the metal alloy into a precise partially liquid state and to keep it there.

6. The apparatus according to claim 1, wherein an induction coil or a laser is deployed in order to subsequently heat the extrusion material and/or in order to preheat the already deposited material layers.

7. The apparatus according to claim 1, wherein the working temperature for producing the semi-solid processing state of the preheated starting material is approximately 600° C.

8. The apparatus according to claim 1, wherein the channel (6) in the region of the induction coil (8) for preheating is formed by a sleeve (9) made of glass or ceramic.

9. The apparatus according to claim 1, wherein the bar-shaped (3) starting material comprising the globulitic structure ready for processing has an average grain size ≤100 μm.

10. The apparatus according to claim 1, wherein the die channel (12) has a ceramic nonstick coating.

11. The apparatus according to claim 1, wherein an ultrasonic generator (14) for maintaining the uniform distribution of the solid (globulites) and liquid material constituents and/or for cleaning purposes is arranged in the region of the die (11).

12. The apparatus according to claim 1, wherein a time control is provided, which can be set such that in the event of globulites which are becoming larger in size emerging, which can lead to clogging of the die, extrusion takes place into the waste, which is why the workpiece table (15) has a waste collector (17).

13. A method for an extrusion-based additive manufacture of products from a thixotropic metal alloy, in which a fed starting material is brought into a semi-solid processing state by heating, extruded through a die (11) and is applied layer by layer to a product to be built up, wherein the not yet liquefied starting material has a texture ready for processing comprising a globulitic structure, is in bar form (3), comprising a male and a female end (4, 5) so that the bars (3) can be joined one after the other to form a rod by the male end (4) engaging in the female end (5) and the rod being utilized as a piston for the extruding by a feed force being introduced into said starting material, wherein a preheating device and a heater in the form of resistance heating are deployed for heating, wherein the heating surface of the resistance heating is kept so small that starting material agings in the form of the enlargement of the globulites are minimized.

14. The method according to claim 13, wherein a demixing between the solid and liquid proportions of the starting material extruding through the die (11) is reduced or prevented by means of ultrasound.

15. The method according to claim 13, wherein globulites which are becoming larger in size, which can cause clogging of the die (11), are extruded into the waste in a time-controlled way.

16. The method according to claim 13, wherein work is carried out during the single-stage method with ±pressing forces of approximately 200 N/cm² in order to also realize, in addition to the extruding, start-stop situations as well as the withdrawal of partially liquid material into the die (11) during controlled extrusion pauses or the penetration of oxide skins, which can form on the outlet side of the die.

17. A feeder (2) for feeding a starting material into an apparatus for the extrusion-based manufacture of products from a thixotropic metal alloy, comprising a storage container (18) for exchangeable bar-shaped (3) starting material and comprising a guide channel (19) for the bar-shaped (3) starting material to a channel (6), in which the starting material is prepared for the extrusion, wherein the bar-shaped (3) starting material is adapted to being connected on the inlet side into the channel (6) to form a rod by a male end (4) of a bar (3) engaging in each case in a female end (5) of a preceding bar (3) and wherein the storage container (18) and the guide channel (19) are filled with a protective gas.

18. The apparatus according to claim 1 wherein the preheating device (7, 8), the heater (10), the die (11) comprising the die channel (12) and the workpiece table (15) are arranged in a housing (1) filled with inert gas.

19. The apparatus according to claim 3, wherein in the case of a worm conveyor a guide groove/web of the joined bars (3) interacts with a guide web/groove of the channel (6) in order to hold the bars (3) in position for the joining and prevents the bars (3) from turning away during propulsion as pistons.
